(19) United States
(12) Patent Application Publication
(10) Pub. No.: US 2026/0136336 A1
(43) Pub. Date: May 14, 2026

(54) METHOD, APPARATUS AND SYSTEM FOR DATA TRANSMISSION

(71) Applicant: Huawei Technologies Co., Ltd., Shenzhen (CN)

(72) Inventors: Huazi Zhang, Zhejiang (CN); Xiaoyan Bi, Shanghai (CN); Jianglei Ma, Ottawa (CA); Wen Tong, Ottawa (CA)

(21) Appl. No.: 19/445,168

(22) Filed: Jan. 9, 2026

Related U.S. Application Data
(63) Continuation of application No. PCT/CN2024/090913, filed on Apr. 30, 2024.
(60) Provisional application No. 63/513,046, filed on Jul. 11, 2023.

(51) Int. Cl. H04W 72/0446; H04W 72/0453; H04W 72/20

(52) U.S. Cl. CPC H04W 72/0446; H04W 72/20; H04W 72/0453

(57) ABSTRACT

A method is provided. The method includes: sending a first set of code bits for a first data transmission over a first set of time domain resources and a first set of frequency domain resources; and receiving first control information corresponding to the first set of code bits over a second set of time domain resources and a second set of frequency domain resources; wherein at least some time resources of the first set of time domain resources and the second set of time domain resources are overlapped, and at least some frequency resources of the first set of frequency domain resources and the second set of frequency domain resources are overlapped.

### CROSS-REFERENCE TO RELATED APPLICATIONS

This application is a continuation of International Patent Application PCT/CN2024/090913, filed on Apr. 30, 2024, which claims the benefit of U.S. Provisional Patent Application No. 63/513,046, filed on Jul. 11, 2023. The entire contents of these disclosures are hereby incorporated by reference.

### TECHNICAL FIELD

The present disclosure generally relates to the field of wireless communication, and in particular, to a method, apparatus and system for data transmission, and a computer readable storage medium.

### BACKGROUND

Two trends are observed toward 6G, one is the ever-crowded spectrum in the sub-3G bands, and the ever-increasing power saving demand.

The past generations of mobile communications (4G and 5G) have adopted higher frequency spectrums for larger bandwidth. However, due to the channel propagation characteristics, the coverage is much smaller than lower-frequency bands, say, sub-3 GHz. The power efficiency is also much lower. As a result, the operators are more willing to prioritize the use of lower bands for better coverage and power saving. As a result, the sub-3 GHz bands will become even more crowded.

A key target of 6G is to reduce the global carbon footprint, at least does not increase the net energy consumption of 5G. However, denser deployment of wireless devices is expected, which naturally increases the inter-cell and inter-device interference. Reducing the transmit energy will have the double benefits of energy saving and interference mitigation, however at the cost of lower received signal-to-interference-plus-noise ratio (SINR). This is a dilemma.

With the current technology, there are several schemes to save transmission energy, improve spectral efficiency and enhance SINR. The first scheme is link adaptation and Hybrid automatic repeat request (hybrid ARQ or HARQ), and the second scheme is power adaptation. The link adaptation and HARQ methods suffer from low spectrum efficiency and excessive latency. The power adaptation suffers from low spectrum efficiency and low power efficiency.

This background information is provided to reveal information believed by the applicant to be of possible relevance to the present disclosure. No admission is necessarily intended, nor should it be construed, that any of the preceding information constitutes prior art against the present disclosure.

### SUMMARY

According to a first aspect, a method for data transmission is provided. The method may be implemented by a transmitting apparatus, or modules in the transmitting apparatus (such as circuits, chips, or chip systems), or logic nodes, logic modules, or software that may perform all or some of the functions of the transmitting apparatus. In an example where the method is applied to a transmitting apparatus, the method comprises: sending a first set of code bits for a first data transmission over a first set of time domain resources and a first set of frequency domain resources; and receiving first control information corresponding to the first set of code bits over a second set of time domain resources and a second set of frequency domain resources; wherein at least some time resources of the first set of time domain resources and the second set of time domain resources are overlapped, and at least some frequency resources of the first set of frequency domain resources and the second set of frequency domain resources are overlapped.

In such case, the resources for sending the first set of code bits for a first data transmission and the resources for receiving the first control information corresponding to the first set of code bits are at least partially overlapped, and transmitting apparatus may receive the first control information in a timely manner.

In some embodiments, the method further comprises: sending an indication of the first set of time domain resources and the second set of time domain resources.

In this way, the receiving apparatus will know on which resources it may receive the first set of code bits for the first data transmission and on which resources it may send the first control information.

In some embodiments, the indication further indicates one or more time domain resources for receiving the first control information corresponding to the first set of code bits, and the one or more time domain resources belongs to the second set of time domain resources.

In this way, the receiving apparatus will know on which resources of second set of time domain resources it may send the first control information.

In some embodiments, the first control information further indicates that the first control information corresponds to the first set of code bits.

In this way, the receiving apparatus will know which set of code bits the first control information corresponds to.

In some embodiments, the method further comprises: sending a second set of code bits for a second data transmission over the first set of time domain resources; and receiving second control information corresponding to the second set of code bits over the second set of time domain resources; wherein at least some time resources of the first set of time domain resources and the second set of time domain resources are overlapped, and the second control information further indicates that the second control information corresponds to the second set of code bits.

In such case, the control information corresponding to different data transmission are transmitted on the shared resources. Therefore the resources will be utilized in a more efficient way.

In some embodiments, the first control information indicates a decoding result of the first set of code bits.

In some embodiments, the first control information includes an acknowledgement (ACK) or a negative acknowledgment (NACK).

In some embodiments, the first control information includes decoder state information (DSI).

In this way, the receiving apparatus will know the decoding confidence about the decoding result.

In some embodiments, the sending the first set of code bits includes: sending the first set of code bits to a first terminal device; and the receiving the first control information includes: receiving the first control information from the first terminal device.

In some embodiments, the sending the second set of code bits includes: sending the second set of code bits to a second terminal device; and the receiving the second control information includes: receiving the second control information from the second terminal device.

In such case, the first set of code bits and the second set of code bits may be transmitted to different receiving apparatus.

In some embodiments, the indication includes one or more timing indicators, and at least one field value of at least one timing indicator maps to 0.

In this way, the first set of code bits and the first control information may be transmitted in a same slot.

In some embodiments, the second set of time domain resources are indicated by a first starting position and a first offset, the first starting position indicates a time resource for sending an initial bit of the first set of code bits, and the first offset is a time interval between two contiguous time resources for sending the first set of code bits.

In such case, the second set of time domain resources may be indicated in a simple way.

In some embodiments, the second set of frequency resources are indicated by a second starting position and a second offset, the second starting position indicates a frequency resource for sending an initial bit of the first set of code bits, and the second offset is a frequency interval between two contiguous frequency resources for sending the first set of code bits.

In such case, the second set of frequency domain resources may be indicated in a simple way.

In some embodiments, the method further comprises: obtaining transmission block size (TBS) based on a minimum transmission length for the first set of code bits.

In such case, more aggressive MCS and higher effective code rate are allowed, leading to higher spectrum efficiency.

In some embodiments, the first control information is identified by an index or ID.

In some embodiments, the indication further indicates whether a negative acknowledgment (NACK) is to be transmitted in a case where the first set of code bits is not successfully decoded.

In such case, feedbacks will be transmitted in a flexible way. Moreover, in a case where NACK is not required to be transmitted, resources will be saved.

In some embodiments, the indication further indicates the interval for resources for transmission of a negative acknowledgment (NACK).

Since it may not be necessary to receive NACKs frequently, the interval for resources for transmission of the NACK transmitting a NACK may be set. In this way, resources for transmission of the NACK are relatively spares, and impact on the receiving and decoding of the PDSCH transmission will be reduced.

In some embodiments, the indication is carried in Radio Resource Control (RRC) signaling or in Downlink Control Information (DCI).

In some embodiments, the first set of time domain resources includes one or more first type of time resources and one or more second type of time resources, wherein the first type of time resources is for the first set of code bits for the first data transmission, and the second type of time resources is for the first set of code bits for the first data transmission and the first control information.

In such case, the first set of time domain resources includes different types of time resources and thus the first set of time domain resources may be utilized in a flexible way.

In some embodiments, the one or more first type of time resources are consecutive in the first set of time domain resources, or the one or more second type of time resources are consecutive in the first set of time domain resources, or both the one or more first types of time resources are consecutive in the first set of time domain resources and the one or more second type of time resources are consecutive in the first set of time domain resources.

In this way, frequent switching between the first type of time resources and the second type of time resources will be avoided, energy consumption will thus be reduced.

In some embodiments, a starting position of the one or more second type of time resources is based on a time for transmitting the first set of code bits of the minimum transmission length and a processing time at a receiving device to process and decode the first set of code bits.

As such, the starting position of the one or more SBFD symbols is determined in a flexible way, and the utilization of the first set of time domain resources may be improved.

In some cases, very frequent SR and CSI is unnecessary, and frequent switching between SBFD and non-SBFD is hardware-unfriendly, one or two symbols per slot may be reserved for SR and CSI. The specific location for SR and CSI can be at the end of a slot, to reduce switching.

In some embodiments, the method further comprises: receiving a scheduling request (SR) or a channel state information (CSI) report over the second set of time domain resources, wherein the first control information is received earlier than the SR or the CSI report.

In this way, the first control information will be transmitted timelier than the SR or CSI.

In some embodiments, the method further comprises: sending a third set of code bits over a third set of time domain resources, wherein the third set of code bits is a redundancy version (RV) of the first set of code bits, and a minimum transmission length for the third set of code bits is shorter than the minimum transmission length for the first set of code bits.

In such case, since the RV corresponds to the retransmission of the first set of code bits, the RV may be decoded once received. In this way, the RV will be timely decoded.

According to a second aspect, a method for data transmission is provided. The method may be implemented by a receiving apparatus, or modules in the receiving apparatus (such as circuits, chips, or chip systems), or logic nodes, logic modules, or software that may perform all or some of the functions of the receiving apparatus. In an example where the method is applied to a receiving apparatus, the method comprises: receiving a first set of code bits for a first data transmission over a first set of time domain resources and a first set of frequency domain resources; and sending first control information corresponding to the first set of code bits over a second set of time domain resources and a second set of frequency domain resources; wherein at least some time resources of the first set of time domain resources and the second set of time domain resources are overlapped, and at least some frequency resources of the first set of frequency domain resources and the second set of frequency domain resources are overlapped.

In some embodiments, the method further comprises: receiving an indication of the first set of time domain resources and the second set of time domain resources.

In some embodiments, the indication further indicates one or more time domain resources for receiving the first control information corresponding to the first set of code bits, and the time domain resources belongs to the second set of time domain resources.

In some embodiments, the first control information further indicates that the first control information corresponds to the first set of code bits.

In some embodiments, the method further comprises: receiving a second set of code bits for a second data transmission over the first set of time domain resources; and sending second control information corresponding to the second set of code bits over the second set of time domain resources; wherein at least some time resources of the first set of time domain resources and the second set of time domain resources are overlapped, and the second control information further indicates that the second control information corresponds to the second set of code bits.

In some embodiments, the first control information indicates a decoding result of the first set of code bits.

In some embodiments, the first control information includes an acknowledgement (ACK) or a negative acknowledgment (NACK).

In some embodiments, the first control information includes decoder state information (DSI).

In some embodiments, the indication includes one or more timing indicators, and at least one field value of at least one timing indicator maps to 0.

In some embodiments, the second set of time domain resources are indicated by a first starting position and a first offset, the first starting position indicates a time resource for sending an initial bit of the first set of code bits, and the first offset is a time interval between two contiguous time resources for sending the first set of code bits.

In some embodiments, the second set of frequency domain resources are indicated by a second starting position and a second offset, the second starting position indicates a frequency resource for sending an initial bit of the first set of code bits, and the second offset is a frequency interval between two contiguous frequency resources for sending the first set of code bits.

In some embodiments, transmission block size (TBS) is based on a minimum transmission length for the first set of code bits.

In some embodiments, the first control information is identified by an index or ID.

In some embodiments, the indication further indicates whether a negative acknowledgment (NACK) is to be transmitted in a case where the first set of code bits is not successfully decoded.

In some embodiments, the indication further indicates the interval for resources for transmission of a negative acknowledgment (NACK).

In some embodiments, the indication is carried in Radio Resource Control (RRC) signaling or in Downlink Control Information (DCI).

In some embodiments, the first set of time domain resources includes one or more first type of time resources and one or more second type of time resources, wherein the first type of time resources is for the first set of code bits for the first data transmission, and the second type of time resources is for the first set of code bits for the first data transmission and the first control information.

In some embodiments, the one or more first type of time resources are consecutive in the first set of time domain resources, or the one or more second type of time resources are consecutive in the first set of time domain resources, or both the one or more first types of time resources are consecutive in the first set of time domain resources and the one or more second type of time resources are consecutive in the first set of time domain resources.

In some embodiments, the one or more first type of time resources are earlier than the one or more second type of time resources.

In some embodiments, a starting position of the one or more second type of time resources is based on a time for receiving the first set of code bits of the minimum transmission length and a processing time at a receiving device to process and decode the first set of code bits.

In some embodiments, the method further comprises: sending a scheduling request (SR) or a channel state information (CSI) report over the second set of time domain resources, wherein the first control information is sent earlier than the SR or the CSI report.

In some embodiments, the method further comprises: receiving a third set of code bits over a third set of time domain resources, wherein the third set of code bits is a redundancy version of the first set of code bits, and a minimum transmission length for the third set of code bits is shorter than the minimum transmission length for the first set of code bits.

According to a third aspect, an apparatus is provided. The apparatus comprises a processor configured to cause the apparatus to perform the method for data transmission in the first aspect or the second aspect, or any possible implementation of the first aspect or the second aspect.

According to a fourth aspect, a computer-readable medium is provided. The computer-readable storage medium has stored thereon computer program instructions that, when executed by a processing circuit of a computer, cause the computer to implement the method for data transmission in the first aspect or the second aspect, or any possible implementation of the first aspect or the second aspect.

According to a fifth aspect, a computer program product is provided. The computer program product has instructions that, when executed by a computer, cause the computer to implement the method for data transmission in the first aspect or the second aspect, or any possible implementation of the first aspect or the second aspect.

According to a sixth aspect, a system is provided. The system comprises: a first apparatus for implementing the method for data transmission in the first aspect or any possible implementation of the first aspect; and a second apparatus for implementing the method for data transmission in the second aspect or any possible implementation of the second aspect.

The advantages brought by any design from the second to sixth aspects can be referred to the first aspect or the different designs of the first aspect, which will not be detailed here.

On the basis of the implementations provided in the above aspects, the present disclosure is able to provide more implementations by further combination.

### BRIEF DESCRIPTION OF THE DRAWINGS

FIG. 1 shows a communication system in which embodiments of the present disclosure may be implemented;

FIGS. 2A and 2B each show another communication system in which embodiments of the present disclosure may be implemented;

FIG. 3 shows an apparatus that wirelessly communicates with at least one apparatus in a communication system in accordance with some embodiments of the present disclosure;

FIG. 4A shows a block diagram of an electronic device or apparatus in accordance with some embodiments of the present disclosure;

FIG. 4B shows a block diagram of a sensing management function entity in accordance with some embodiments of the present disclosure;

FIG. 5A shows a schematic diagram of different redundancy versions (RVs) in the related art;

FIG. 5B shows an example feedback mechanism in the related art;

FIG. 6 shows a schematic diagram of method for data transmission in the related art;

FIG. 7 shows a signaling chart in accordance with some embodiments of the present disclosure;

FIG. 8 shows a schematic diagram of method for data transmission in accordance with some embodiments of the present disclosure;

FIG. 9 shows another schematic diagram of method for data transmission in accordance with some embodiments of the present disclosure;

FIG. 10 shows yet another schematic diagram of method for data transmission in accordance with some embodiments of the present disclosure;

FIG. 11 shows a schematic diagram of time-frequency resource allocation in sub-band full duplex (SBFD) in the related art;

FIG. 12 shows yet another schematic diagram of method for data transmission in accordance with some embodiments of the present disclosure;

FIG. 13 shows a schematic diagram of time-frequency resource allocation in SBFD in accordance with some embodiments of the present disclosure;

FIG. 14 shows another schematic diagram of time-frequency resource allocation in SBFD in accordance with some embodiments of the present disclosure; and

FIG. 15 shows yet another schematic diagram of method for data transmission in accordance with some embodiments of the present disclosure.

### DETAILED DESCRIPTION

To solve the above problems, the present disclosure provides a method for data transmission, which includes multiple solutions. The solutions can be implemented in next-generation mobile and wireless network service, cloud and edge computing service, and sensing services. The method will be particularly useful for automated manufacturing systems in smart factories. It applies to other intelligent vertical scenarios such as ports, delivery systems and medical systems.

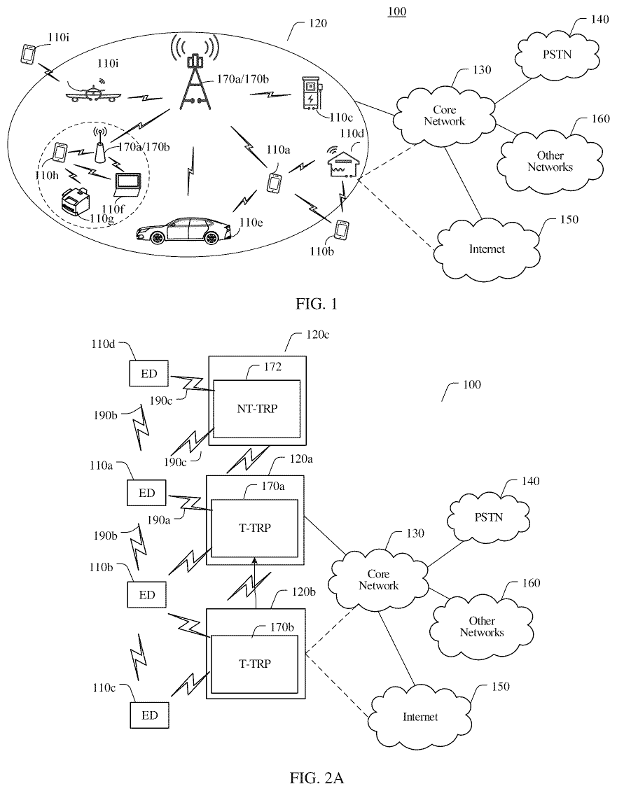

Referring to FIG. 1, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also, the communication system 100 comprises a public switched telephone network (PSTN) 140, the internet 150, and other networks 160.

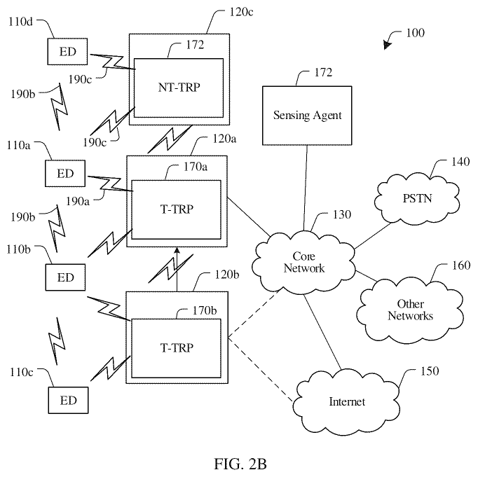

FIG. 2A illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of the terrestrial communication system and the non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system. In the example shown, the communication system 100 includes electronic devices (ED) 110a-110d (generically referred to as ED 110), radio access networks (RANs) 120a-120b, non-terrestrial communication network 120c, a core network 130, a public switched telephone network (PSTN) 140, the internet 150, and other networks 160. The RANs 120a-120b include respective base stations (BSs) 170a-170b, which may be generically referred to as terrestrial transmit and receive points (T-TRPs) 170a-170b. The non-terrestrial communication network 120c includes an access node 120c, which may be generically referred to as a non-terrestrial transmit and receive point (NT-TRP) 172.

Any ED 110 may be alternatively or additionally configured to interface, access, or communicate with any other T-TRP 170a-170b and NT-TRP 172, the internet 150, the core network 130, the PSTN 140, the other networks 160, or any combination of the preceding. In some examples, ED 110a may communicate an uplink and/or downlink transmission over an interface 190a with T-TRP 170a. In some examples, the EDs 110a, 110b and 110d may also communicate directly with one another via one or more sidelink air interfaces 190b. In some examples, ED 110d may communicate an uplink and/or downlink transmission over an interface 190c with NT-TRP 172.

The air interfaces 190a and 190b may use similar communication technology, such as any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs and one or multiple NT-TRPs for multicast transmission.

The RANs 120a and 120b are in communication with the core network 130 to provide the EDs 110a 110b, and 110c with various services such as voice, data, and other services. The RANS 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

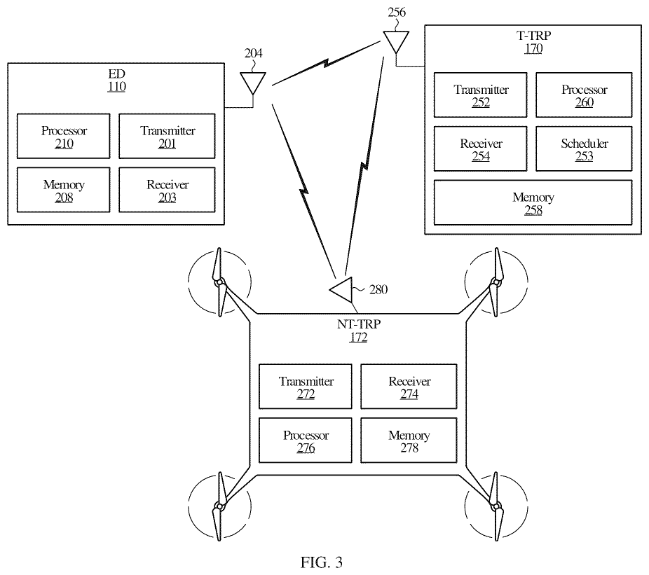

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 3, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 1). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 276 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP)), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distribute unit (DU), positioning node, among other possibilities. The T-TRP 170 may be macro BSs, pico BSs, relay node, donor node, or the like, or combinations thereof. The T-TRP 170 may refer to the foregoing devices or apparatus (e.g. communication module, modem, or chip) in the foregoing devices.

In different systems, the CU (or the CU-CP and the CU-UP), the DU, or the RU may also have different names, but a person skilled in the art may understand meanings thereof. For example, in an ORAN system, a CU may also be referred to as an open CU (O-CU), a DU may also be referred to as an open DU (O-DU), and a CU-CP may also be referred to as an open CU-CP (O-CU-CP). The CU-UP may also be referred to as an open CU-UP (O-CU-UP), and the RU may also be referred to as an open RU (O-RU).

Any one of the CU (or the CU-CP, the CU-UP), the DU, and the RU may be implemented by using a software module, a hardware module, or a combination of a software module and a hardware module.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

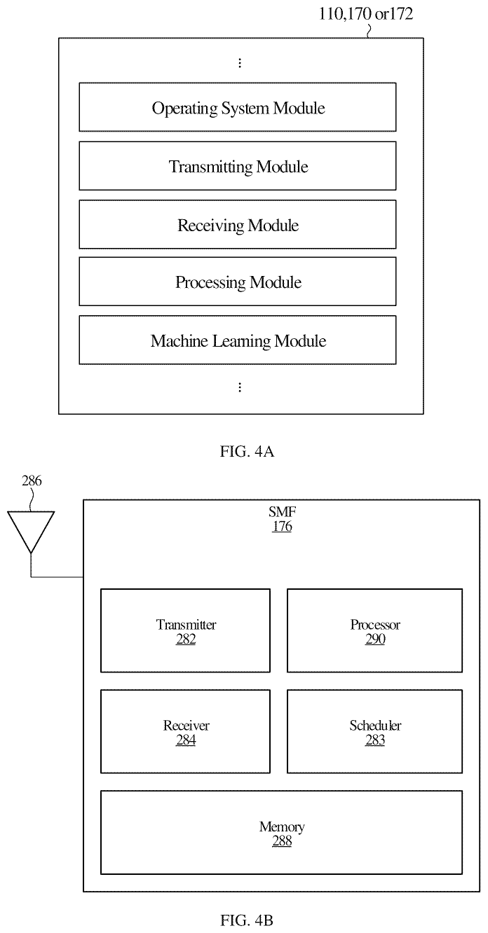

One or more steps of the embodiment methods provided herein may be performed by corresponding units or modules, according to FIG. 4A. FIG. 4A illustrates units or modules in a device, such as in ED 110, in T-TRP 170, or in NT-TRP 172. For example, a signal may be transmitted by a transmitting unit or a transmitting module. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

6G Intelligent Air Interface

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g. data) over a wireless communications link. The wireless communications link may support a link between a radio access network and user equipment (e.g. a “Uu” link), and/or the wireless communications link may support a link between device and device, such as between two user equipments (e.g. a “sidelink”), and/or the wireless communications link may support a link between a non-terrestrial (NT)-communication network and user equipment (UE). The following are some examples for the above components:

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform, and low Peak to Average Power Ratio Waveform (low PAPR WF).

A frame structure component may specify a configuration of a frame or group of frames. The frame structure component may indicate one or more of a time, frequency, pilot signature, code, or other parameter of the frame or group of frames. More details of frame structure will be discussed below.

A multiple access scheme component may specify multiple access technique options, including technologies defining how communicating devices share a common physical channel, such as: Time Division Multiple Access (TDMA), Frequency Division Multiple Access (FDMA), Code Division Multiple Access (CDMA), Single Carrier Frequency Division Multiple Access (SC-FDMA), Low Density Signature Multicarrier Code Division Multiple Access (LDS-MC-CDMA), Non-Orthogonal Multiple Access (NOMA), Pattern Division Multiple Access (PDMA), Lattice Partition Multiple Access (LPMA), Resource Spread Multiple Access (RSMA), and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources, and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission, and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes, and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all concept.” For example, the components within the air interface cannot be changed or adapted once the air interface is defined. In some implementations, only limited parameters or modes of an air interface, such as a cyclic prefix (CP) length or a multiple input multiple output (MIMO) mode, can be configured. In some embodiments, an air interface design may provide a unified or flexible framework to support below 6 GHz and beyond 6 GHz frequency (e.g., mmWave) bands for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain, and a frequency domain self-contained design may support more flexible radio access network (RAN) slicing through channel resource sharing between different services in both frequency and time.

### Frame Structure

A frame structure is a feature of the wireless communication physical layer that defines a time domain signal transmission structure, e.g. to allow for timing reference and timing alignment of basic time domain transmission units. Wireless communication between communicating devices may occur on time-frequency resources governed by a frame structure. The frame structure may sometimes instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g. uplink vs. downlink) occur in different frequency bands. TDD communication is when transmissions in different directions (e.g. uplink vs. downlink) occur over different time durations. FD communication is when transmission and reception occurs on the same time-frequency resource, i.e. a device can both transmit and receive on the same frequency resource concurrently in time.

One example of a frame structure is a frame structure in long-term evolution (LTE) having the following specifications: each frame is 10 ms in duration; each frame has 10 subframes, which are each 1 ms in duration; each subframe includes two slots, each of which is 0.5 ms in duration; each slot is for transmission of 7 OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD has to be the integer time of OFDM symbol duration.

Another example of a frame structure is a frame structure in new radio (NR) having the following specifications: multiple subcarrier spacings are supported, each subcarrier spacing corresponding to a respective numerology; the frame structure depends on the numerology, but in any case the frame length is set at 10 ms, and consists of ten subframes of 1 ms each; a slot is defined as 14 OFDM symbols, and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing a slot length is 1 ms, and for 30 kHz subcarrier spacing a slot length is 0.5 ms. The NR frame structure may have more flexibility than the LTE frame structure.

Another example of a frame structure is an example flexible frame structure, e.g. for use in a 6G network or later. In a flexible frame structure, a symbol block may be defined as the minimum duration of time that may be scheduled in the flexible frame structure. A symbol block may be a unit of transmission having an optional redundancy portion (e.g. CP portion) and an information (e.g. data) portion. An OFDM symbol is an example of a symbol block. A symbol block may alternatively be called a symbol. Embodiments of flexible frame structures include different parameters that may be configurable, e.g. frame length, subframe length, symbol block length, etc. A non-exhaustive list of possible configurable parameters in some embodiments of a flexible frame structure include:

(1) Frame: The frame length need not be limited to 10 ms, and the frame length may be configurable and change over time. In some embodiments, each frame includes one or multiple downlink synchronization channels and/or one or multiple downlink broadcast channels, and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set as 5 ms for autonomous vehicle applications. As another example, smart meters on houses may not require fast initial access, in which case the frame length may be set as 20 ms for smart meter applications.

(2) Subframe duration: A subframe might or might not be defined in the flexible frame structure, depending upon the implementation. For example, a frame may be defined to include slots, but no subframes. In frames in which a subframe is defined, e.g. for time domain alignment, then the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

(3) Slot configuration: A slot might or might not be defined in the flexible frame structure, depending upon the implementation. In frames in which a slot is defined, then the definition of a slot (e.g. in time duration and/or in number of symbol blocks) may be configurable. In one embodiment, the slot configuration is common to all UEs or a group of UEs. For this case, the slot configuration information may be transmitted to UEs in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration can be transmitted independently from the frame configuration signaling and/or subframe configuration signaling. In general, the slot configuration may be system common, base station common, UE group common, or UE specific.

(4) Subcarrier spacing (SCS): SCS is one parameter of scalable numerology which may allow the SCS to possibly range from 15 KHz to 480 KHz. The SCS may vary with the frequency of the spectrum and/or maximum UE speed to minimize the impact of the Doppler shift and phase noise. In some examples, there may be separate transmission and reception frames, and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g. if more flexible symbol durations are implemented using inverse discrete Fourier transform (IDFT) instead of fast Fourier transform (FFT). Additional examples of frame structures can be used with different SCSs.

(5) Flexible transmission duration of basic transmission unit: The basic transmission unit may be a symbol block (alternatively called a symbol), which in general includes a redundancy portion (referred to as the CP) and an information (e.g. data) portion, although in some embodiments the CP may be omitted from the symbol block. The CP length may be flexible and configurable. The CP length may be fixed within a frame or flexible within a frame, and the CP length may possibly change from one frame to another, or from one group of frames to another group of frames, or from one subframe to another subframe, or from one slot to another slot, or dynamically from one scheduling to another scheduling. The information (e.g. data) portion may be flexible and configurable. Another possible parameter relating to a symbol block that may be defined is ratio of CP duration to information (e.g. data) duration. In some embodiments, the symbol block length may be adjusted according to: channel condition (e.g. multi-path delay, Doppler); and/or latency requirement; and/or available time duration. As another example, a symbol block length may be adjusted to fit an available time duration in the frame.

(6) Flexible switch gap: A frame may include both a downlink portion for downlink transmissions from a base station, and an uplink portion for uplink transmissions from UEs. A gap may be present between each uplink and downlink portion, which is referred to as a switching gap. The switching gap length (duration) may be configurable. A switching gap duration may be fixed within a frame or flexible within a frame, and a switching gap duration may possibly change from one frame to another, or from one group of frames to another group of frames, or from one subframe to another subframe, or from one slot to another slot, or dynamically from one scheduling to another scheduling.

### Cell/Bandwidth Parts (BWPs)/Occupied Bandwidth

A device, such as a base station, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g. the center or lowest or highest frequency of the carrier. A carrier may be on licensed or unlicensed spectrum. Wireless communication with the device may also or instead occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and optionally one or multiple uplink resources, or a cell may include one or multiple uplink resources and optionally one or multiple downlink resources, or a cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may instead or additionally include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g. a carrier may have a bandwidth of 20 MHz and consist of one BWP, or a carrier may have a bandwidth of 80 MHz and consist of two adjacent contiguous BWPs, etc. In other embodiments, a BWP may have one or more carriers, e.g. a BWP may have a bandwidth of 40 MHz and consists of two adjacent contiguous carriers, where each carrier has a bandwidth of 20 MHz. In some embodiments, a BWP may comprise non-contiguous spectrum resources which consists of non-contiguous multiple carriers, where the first carrier of the non-contiguous multiple carriers may be in mmW band, the second carrier may be in a low band (such as 2 GHz band), the third carrier (if it exists) may be in THz band, and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage β/2 of the total mean transmitted power, for example, the value of β/2 is taken as 0.5%.

The carrier, the BWP, or the occupied bandwidth may be signaled by a network device (e.g. base station) dynamically, e.g. in physical layer control signaling such as DCI, or semi-statically, e.g. in radio resource control (RRC) signaling or in the medium access control (MAC) layer, or be predefined based on the application scenario; or be determined by the UE as a function of other parameters that are known by the UE, or may be fixed, e.g. by a standard.

### Timing Reference Point

In current networks, frame timing and synchronization is established based on synchronization signals, such as a primary synchronization signal (PSS) and a secondary synchronization signal (SSS). Notably, known frame timing and synchronization strategies involve adding a timestamp, e.g., (xx0:yy0:zz), to a frame boundary, where xx0, yy0, zz in the timestamp may represent a time format such as hour, minute, and second, respectively.

It is anticipated that diverse applications and use cases in future networks may involve usage of different periods of frames, slots and symbols to satisfy the different requirements, functionalities and Quality of Service (QOS) types. It follows that usage of different periods of frames to satisfy these applications may present challenges for frame timing alignment among diverse frame structures. Consider, for example, frame timing alignment for a TDD configuration in neighboring carrier frequency bands or among sub-bands (or bandwidth parts) of one channel/carrier bandwidth.

The present disclosure relates, generally, to mobile, wireless communication and, in particular embodiments, to a frame timing alignment/realignment, where the frame timing alignment/realignment may comprise a timing alignment/realignment in terms of a boundary of a symbol, a slot or a sub-frame within a frame; or a frame (thus the frame timing alignment/realignment here is more general, not limiting to the cases where a timing alignment/realignment is from a frame boundary only). Also, in this application, relative timing to a frame or frame boundary should be interpreted in a more general sense, i.e., the frame boundary means a timing point of a frame element with the frame such as (starting or ending of) a symbol, a slot or subframe within a frame, or a frame. In the following, the phrases “(frame) timing alignment or timing realignment” and “relative timing to a frame boundary” are used in more general sense described in above.

In overview, aspects of the present application relate to a network device, such as a base station 170, referenced hereinafter as a TRP 170, transmitting signaling that carries a timing realignment indication message. The timing realignment indication message includes information allowing a receiving UE 110 (an example of ED 110) to determine a timing reference point. On the basis of the timing reference point, transmission of frames, by the UE 110, may be aligned. In some aspects of the present application, the frames that become aligned are in different sub-bands of one carrier frequency band. In other aspects of the present application, the frames that become aligned are found in neighboring carrier frequency bands.

On the TRP 170 side, aspects of the present application relate to use of one or more types of signaling to indicate the timing realignment (or/and timing correction) message. Two example types of signaling are provided here to show the schemes. The first example type of signaling may be referenced as cell-specific signaling, examples of which include group common signaling and broadcast signaling. The second example type of signaling may be referenced as UE-specific signaling. One of these two types of signaling or a combination of the two types of signaling may be used to transmit a timing realignment indication message. The timing realignment indication message may be shown to notify one or more UEs 110 of a configuration of a timing reference point. References, hereinafter, to the term “UE 110” may be understood to represent reference to a broad class of generic wireless communication devices within a cell (i.e., a network receiving node, such as a wireless device, a sensor, a gateway, a router, etc.), that is, being served by the TRP 170. A timing reference point is a timing reference instant and may be expressed in terms of a relative timing, in view of a timing point in a frame, such as (starting or ending boundary of) a symbol, a slot or a sub-frame within a frame; or a frame. For a simple description in the following, the term “a frame boundary” is used to represent a boundary of possibly a symbol, a slot or a sub-frame within a frame; or a frame. Thus, the timing reference point may be expressed in terms of a relative timing, in view of a current frame boundary, e.g., the start of the current frame. Alternatively, the timing reference point may be expressed in terms of an absolute timing based on certain standards timing reference such as a GNSS (e.g., GPS), Coordinated Universal Time (“UTC”), etc. In the absolute timing version of the timing reference point, a timing reference point may be explicitly stated.

The timing reference point may be shown to allow for timing adjustments to be implemented at the UEs 110. The timing adjustments may be implemented for improvement of accuracy for a clock at the UE 110. Alternatively, or additionally, the timing reference point may be shown to allow for adjustments to be implemented in future transmissions made from the UEs 110. The adjustments may be shown to cause realignment of transmitted frames at the timing reference point. Note that the realignment of transmitted frames at the timing reference point may comprise the timing realignment from (the starting boundary of) a symbol, a slot or a sub-frame within a frame; or a frame at the timing reference point for one or more UEs and one or more BSs (in a cell or a group of cells), which applies across the application below.

At UE 110 side, the UE 110 may monitor for the timing realignment indication message. Responsive to receiving the timing realignment indication message, the UE 110 may obtain the timing reference point and take steps to cause frame realignment at the timing reference point. Those steps may, for example, include commencing transmission of a subsequent frame at the timing reference point.

Furthermore, or alternatively, before monitoring for the timing realignment indication message, the UE 110 may cause the TRP 170 to transmit the timing realignment indication message by transmitting, to the TRP 170, a request for a timing realignment, that is, a timing realignment request message. Responsive to receiving the timing realignment request message, the TRP 170 may transmit, to the UE 110, a timing realignment indication message including information on a timing reference point, thereby allowing the UE 110 to implement a timing realignment (or/and a timing adjustment including clock timing error correction), wherein the timing realignment is in terms of (e.g., a starting boundary of) a symbol, a slot or a sub-frame within a frame; or a frame for UEs and base station(s) in a cell (or a group of cells).

According to aspects of the present application, a TRP 170 associated with a given cell may transmit a timing realignment indication message. The timing realignment indication message may include enough information to allow a receiver of the message to obtain a timing reference point. The timing reference point may be used, by one or more UEs 110 in the given cell, when performing a timing realignment (or/and a timing adjustment including clock timing error correction).

According to aspects of the present application, the timing reference point may be expressed, within the timing realignment indication message, relative to a frame boundary (where, as previously described and to be applicable below across the application, a frame boundary can be a boundary of a symbol, a slot or a sub-frame with a frame; or a frame). The timing realignment indication message may include a relative timing indication, Δt. It may be shown that the relative timing indication, Δt, expresses the timing reference point as occurring a particular duration, i.e., Δt, subsequent to a frame boundary for a given frame. Since the frame boundary is important to allowing the UE 110 to determine the timing reference point, it is important that the UE 110 be aware of the given frame that has the frame boundary of interest. Accordingly, the timing realignment indication message may also include a system frame number (SFN) for the given frame.

It is known, in 5G NR, that the SFN is a value in range from 0 to 1023, inclusive. Accordingly, 10 bits may be used to represent a SFN. When a SFN is carried by an SSB, six of the 10 bits for the SFN may be carried in a Master Information Block (MIB) and the remaining four bits of the 10 bits for the SFN may be carried in a Physical Broadcast Channel (PBCH) payload.

Optionally, the timing realignment indication message may include other parameters. The other parameters may, for example, include a minimum time offset. The minimum time offset may establish a duration of time preceding the timing reference point. The UE 110 may rely upon the minimum time offset as an indication that DL signaling, including the timing realignment indication message, will allow the UE 110 enough time to detect the timing realignment indication message to obtain information on the timing reference point.

### 6G Integrated Sensing and Communication

### Generic Background

User Equipment (UE) position information is often used in cellular communication networks to improve various performance metrics for the network. Such performance metrics may, for example, include capacity, agility, and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including its location in a global coordinate system, its velocity and direction of movement in the global coordinate system, orientation information, and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency, or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems

### Sensing Node, Sensing Management Function

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. The sensing agent 174 is an example of a sensing node that is dedicated to sensing. Unlike the EDs 110 and BS 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a, and transmit this information to the base station 170a via the core network 130. Although only one sensing agent 174 is shown in FIG. 2B, any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

As shown in FIG. 4B, the SMF 176, when implemented as a physically independent entity, includes at least one processor 290, at least one transmitter 282, at least one receiver 284, one or more antennas 286, and at least one memory 288. A transceiver, not shown, may be used instead of the transmitter 282 and receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing, or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy.

### Sensing Channel

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal, and a second set of channels may be used to transmit a communications signal. In some embodiments, each channel in the first set of channels and each channel in the second set of channels is a logical channel, a transport channel, or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) is used to carry control information for both sensing and communication. Alternatively, separate physical layer control channels may be used to carry separate control information for communication and sensing. For example, PUCCH-S and PUCCH-C could be used for uplink control for sensing and communication respectively, and PDCCH-S and PDCCH-C for downlink control for sensing and communication respectively.

Different combinations of shared and dedicated channels for sensing and communication, at each of the physical, transport, and logical layers, are possible.

### Radar

The term RADAR originates from the phrase Radio Detection and Ranging; however, expressions with different forms of capitalization (i.e., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include frequency modulated continuous wave (FMCW) and ultra-wideband (UWB) waveforms.

Radar systems can be monostatic, bi-static, or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

### Half-Duplex and Full-Duplex

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g. in the millimeter wave bands), and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires the sensing node to have full-duplex capability. A half-duplex node may perform monostatic sensing with certain limitations, such as in a pulsed radar with a specific duty cycle and ranging capability.

### Sensing Signal Waveform and Frame Structure

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp,” orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−F_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp slope. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt2} in the baseband representation.

### 6G Integrated TN &NTN

A terrestrial communication system may also be referred to as a land-based or ground-based communication system, although a terrestrial communication system can also, or instead, be implemented on or in water. The non-terrestrial communication system may bridge the coverage gaps for underserved areas by extending the coverage of cellular networks through non-terrestrial nodes, which will be key to ensuring global seamless coverage and providing mobile broadband services to unserved/underserved regions, in this case, it is hardly possible to implement terrestrial access-points/base-stations infrastructure in the areas like oceans, mountains, forests, or other remote areas.

The terrestrial communication system may be a wireless communications using 5G technology and/or later generation wireless technology (e.g., 6G or later). In some examples, the terrestrial communication system may also accommodate some legacy wireless technology (e.g., 3G or 4G wireless technology). The non-terrestrial communication system may be a communications using the satellite constellations like conventional Geo-Stationary Orbit (GEO) satellites which utilizing broadcast public/popular contents to a local server, Low earth orbit (LEO) satellites establishing a better balance between large coverage area and propagation path-loss/delay, stabilize satellites in very low earth orbits (VLEO) enabling technologies substantially reducing the costs for launching satellites to lower orbits, high altitude platforms (HAPs) providing a low path-loss air interface for the users with limited power budget, or Unmanned Aerial Vehicles (UAVs) (or unmanned aerial system (UAS)) achieving a dense deployment since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs coupled to integrate satellite communications to cellular networks emerging 3D vertical networks consist of many moving (other than geostationary satellites) and high altitude access points such as UAVs, HAPs and VLEOs.

### 6G MIMO

Multiple input multiple-output (MIMO) technology allows an antenna array of multiple antennas to perform signal transmissions and receptions to meet high transmission rate requirement. The above ED110 and T-TRP 170, and/or NT-TRP use MIMO to communicate over the wireless resource blocks. MIMO utilizes multiple antennas at the transmitter and/or receiver to transmit wireless resource blocks over parallel wireless signals. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the above T-TRP 170, and/or NT-TRP 172 configured with a large number of antennas has gained wide attentions from the academia and the industry. In the large-scale MIMO system, the T-TRP 170, and/or NT-TRP 172 is generally configured with more than ten antenna units (such as 128 or 256), and serves for dozens of the ED 110 (such as 40) in the meanwhile. A large number of antenna units of the T-TRP 170, and NT-TRP 172 can greatly increase the degree of spatial freedom of wireless communication, greatly improve the transmission rate, spectrum efficiency and power efficiency, and eliminate the interference between cells to a large extent. The increase of the number of antennas makes each antenna unit be made in a smaller size with a lower cost. Using the degree of spatial freedom provided by the large-scale antenna units, the T-TRP 170, and NT-TRP 172 of each cell can communicate with many ED 110 in the cell on the same time-frequency resource at the same time, thus greatly increasing the spectrum efficiency. A large number of antenna units of the T-TRP 170, and/or NT-TRP 172 also enable each user to have better spatial directivity for uplink and downlink transmission, so that the transmitting power of the T-TRP 170, and/or NT-TRP 172 and a ED 110 is obviously reduced, and the power efficiency is greatly increased. When the antenna number of the T-TRP 170, and/or NT-TRP 172 is sufficiently large, random channels between each ED 110 and the T-TRP 170, and/or NT-TRP 172 can approach to be orthogonal, and the interference between the cell and the users and the effect of noises can be eliminated. The plurality of advantages described above enable the large-scale MIMO to have a magnificent application prospect.

A MIMO system may include a receiver connected to a receive (Rx) antenna, a transmitter connected to transmit (Tx) antenna, and a signal processor connected to the transmitter and the receiver. Each of the Rx antenna and the Tx antenna may include a plurality of antennas. For instance, the Rx antenna may have an ULA antenna array in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include:

Panel: unit of antenna group, or antenna array, or antenna sub-array which can control its Tx or Rx beam independently.

Beam: A beam is formed by performing amplitude and/or phase weighting on data transmitted or received by at least one antenna port, or may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. The beam information may be a beam identifier, or antenna port(s) identifier, or CSI-RS resource identifier, or SSB resource identifier, or SRS resource identifier, or other reference signal resource identifier.

### 6G AI/ML

Artificial Intelligence technologies can be applied in communication, including artificial intelligence or machine learning (AI/ML) based communication in the physical layer and/or AI/ML based communication in the higher layer, e.g., medium access control (MAC) layer. For example, in the physical layer, the AI/ML based communication may aim to optimize component design and/or improve the algorithm performance. For the MAC layer, the AI/ML based communication may aim to utilize the AI/ML capability for learning, prediction, and/or making a decision to solve a complicated optimization problem with possible better strategy and/or optimal solution, e.g. to optimize the functionality in the MAC layer, e.g. intelligent TRP management, intelligent beam management, intelligent channel resource allocation, intelligent power control, intelligent spectrum utilization, intelligent modulation and coding scheme (MCS), intelligent hybrid automatic repeat request (HARQ) strategy, intelligent transmit/receive (Tx/Rx) mode adaption, etc.

The following are some terminologies which are used in AI/ML field:

### Data Collection

Data is the very important component for AI/ML techniques. Data collection is a process of collecting data by the network nodes, management entity, or UE for the purpose of AI/ML model training, data analytics and inference.

### AI/ML Model Training

AI/ML model training is a process to train an AI/ML Model by learning the input/output relationship in a data driven manner and obtaining the trained AI/ML Model for inference.

### AI/ML Model Inference

A process of using a trained AI/ML model to produce a set of outputs based on a set of inputs.

### AI/ML Model Validation

As a sub-process of training, validation is used to evaluate the quality of an AI/ML model using a dataset different from the one used for model training. Validation can help selecting model parameters that generalize beyond the dataset used for model training. The model parameter after training can be adjusted further by the validation process.

### AI/ML Model Testing

Similar with validation, testing is also a sub-process of training, and it is used to evaluate the performance of a final AI/ML model using a dataset different from the one used for model training and validation. Differently from AI/ML model validation, testing do not assume subsequent tuning of the model.

### Online Training:

Online training means an AI/ML training process where the model being used for inference is typically continuously trained in (near) real-time with the arrival of new training samples.

### Offline Training:

An AI/ML training process where the model is trained based on collected dataset, and where the trained model is later used or delivered for inference.

### AI/ML Model Delivery/Transfer

A generic term referring to delivery of an AI/ML model from one entity to another entity in any manner. Delivery of an AI/ML model over the air interface includes either parameters of a model structure known at the receiving end or a new model with parameters. Delivery may contain a full model or a partial model.

### Life Cycle Management (LCM)

When the AI/ML model is trained and/or inferred at one device, it is necessary to monitor and manage the whole AI/ML process to guarantee the performance gain obtained by AI/ML technologies. For example, due to the randomness of wireless channels and the mobility of UEs, the propagation environment of wireless signals changes frequently. Nevertheless, it is difficult for an AI/ML model to maintain optimal performance in all scenarios for all the time, and the performance may even deteriorate sharply in some scenarios. Therefore, the lifecycle management (LCM) of AI/ML models is essential for sustainable operation of AI/ML in NR air-interface.

Life cycle management covers the whole procedure of AI/ML technologies which applied on one or more nodes. In specific, it includes at least one of the following sub-process: data collection, model training, model identification, model registration, model deployment, model configuration, model inference, model selection, model activation, deactivation, model switching, model fallback, model monitoring, model update, model transfer/delivery and UE capability report.

Model monitoring can be based on inference accuracy, including metrics related to intermediate key performance indicator (KPI)s, and it can also be based on system performance, including metrics related to system performance KPIs, e.g., accuracy and relevance, overhead, complexity (computation and memory cost), latency (timeliness of monitoring result, from model failure to action) and power consumption. Moreover, data distribution may shift after deployment due to the environment changes, thus the model based on input or output data distribution should also be considered.

### Supervised Learning:

The goal of supervised learning algorithms is to train a model that maps feature vectors (inputs) to labels (output), based on the training data which includes the example feature-label pairs. The supervised learning can analyze the training data and produce an inferred function, which can be used for mapping the inference data.

Supervised learning can be further divided into two types: Classification and Regression. Classification is used when the output of the AI/ML model is categorical i.e. with two or more classes. Regression is used when the output of the AI/ML model is a real or continuous value.

### Unsupervised Learning:

In contrast to supervised learning where the AI/ML models learn to map the input to the target output, the unsupervised methods learn concise representations of the input data without the labelled data, which can be used for data exploration or to analyze or generate new data. One typical unsupervised learning is clustering which explores the hidden structure of input data and provide the classification results for the data.

### Reinforce Learning:

Reinforce learning is used to solve sequential decision-making problems. Reinforce learning is a process of training the action of intelligent agent from input (state) and a feedback signal (reward) in an environment. In reinforce learning, an intelligent agent interacts with an environment by taking an action to maximize the cumulative reward. Whenever the intelligent agent takes one action, the current state in the environment may transfer to the new state, and the new state resulted by the action will bring to the associated reward. Then the intelligent agent can take the next action based on the received reward and new state in the environment. During the training phase, the agent interacts with the environment to collect experience. The environments often mimicked by the simulator since it is expensive to directly interact with the real system. In the inference phase, the agent can use the optimal decision-making rule learned from the training phase to achieve the maximal accumulated reward.

### Federated Learning:

Federated learning (FL) is a machine learning technique that is used to train an AI/ML model by a central node (e.g., server) and a plurality of decentralized edge nodes (e.g., UEs, next Generation NodeBs, “gNBs”).

According to the wireless FL technique, a server may provide, to an edge node, a set of model parameters (e.g., weights, biases, gradients) that describe a global AI/ML model. The edge node may initialize a local AI/ML model with the received global AI/ML model parameters. The edge node may then train the local AI/ML model using local data samples to, thereby, produce a trained local AI/ML model. The edge node may then provide, to the serve, a set of AI/ML model parameters that describe the local AI/ML model.

Upon receiving, from a plurality of edge nodes, a plurality of sets of AI/ML model parameters that describe respective local AI/ML models at the plurality of edge nodes, the server may aggregate the local AI/ML model parameters reported from the plurality of UEs and, based on such aggregation, update the global AI/ML model. A subsequent iteration progresses much like the first iteration. The server may transmit the aggregated global model to a plurality of edge nodes. The above procedure are performed multiple iterations until the global AI/ML model is considered to be finalized, e.g, the AI/ML model is converged or the training stopping conditions are satisfied.

Notably, the wireless FL technique does not involve exchange of local data samples. Indeed, the local data samples remain at respective edge nodes.

AI technologies (which encompass ML technologies) may be applied in communication, including AI-based communication in the physical layer and/or AI-based communication in the MAC layer. For the physical layer, the AI communication may aim to optimize component design and/or improve the algorithm performance. For example, AI may be applied in relation to the implementation of: channel coding, channel modelling, channel estimation, channel decoding, modulation, demodulation, MIMO, waveform, multiple access, physical layer element parameter optimization and update, beam forming, tracking, sensing, and/or positioning, etc. For the MAC layer, the AI communication may aim to utilize the AI capability for learning, prediction, and/or making a decision to solve a complicated optimization problem with possible better strategy and/or optimal solution, e.g. to optimize the functionality in the MAC layer. For example, AI may be applied to implement: intelligent TRP management, intelligent beam management, intelligent channel resource allocation, intelligent power control, intelligent spectrum utilization, intelligent MCS, intelligent HARQ strategy, and/or intelligent transmission/reception mode adaption, etc.

An AI architecture may involve multiple nodes, where the multiple nodes may possibly be organized in one of two modes, i.e., centralized and distributed, both of which may be deployed in an access network, a core network, or an edge computing system or third party network. A centralized training and computing architecture is restricted by possibly large communication overhead and strict user data privacy. A distributed training and computing architecture may comprise several frameworks, e.g., distributed machine learning and federated learning. In some embodiments, an AI architecture may comprise an intelligent controller which can perform as a single agent or a multi-agent, based on joint optimization or individual optimization. New protocols and signaling mechanisms are desired so that the corresponding interface link can be personalized with customized parameters to meet particular requirements while minimizing signaling overhead and maximizing the whole system spectrum efficiency by personalized AI technologies.

New protocols and signaling mechanisms are provided for operating within and switching between different modes of operation, including between AI and non-AI modes, and for measurement and feedback to accommodate the different possible measurements and information that may need to be fed back, depending upon the implementation.

An air interface that uses AI as part of the implementation, e.g. to optimize one or more components of the air interface, will be referred to herein as an “AI enabled air interface.” In some embodiments, there may be two types of AI operation in an AI enabled air interface: both the network and the UE implement learning; or learning is only applied by the network.

With the current technology, there are several schemes to save transmission energy, improve spectral efficiency and enhance SINR. The first scheme is power adaptation, and the second scheme is link adaptation and Hybrid automatic repeat request (hybrid ARQ or HARQ).

As for power adaptation, due to channel (CQI) estimation error and unpredictable interference from neighboring cells and devices, the perceived SINR may be insufficient for reliable communications. In these cases, an effective method is to ramp up transmit power, until the packet is successfully decoded.

However, the power adaptation method suffers from the following drawback: the abuse of power ramp-up actions will lead to even higher inter-cell/inter-UE interference, thus reducing the overall system energy efficiency. In the case of poor interference alignment, the excessive interference may even bring down the average perceived SINR.

HARQ is a combination of high-rate forward error correction (FEC) and automatic repeat request (ARQ). If the initial transmission fails, a retransmission is automatically requested until the successful decoding of the packet. The retransmission is conducted upon request, and is scheduled by a base station (BS).

For data channel, the BS will schedule a modulation and coding scheme (MCS) such that the target BLER is around 0.1, which means one out of ten code blocks (CB) will have decode error. In case of an error, a retransmission request is sent via the negative acknowledgement (NACK) signal.

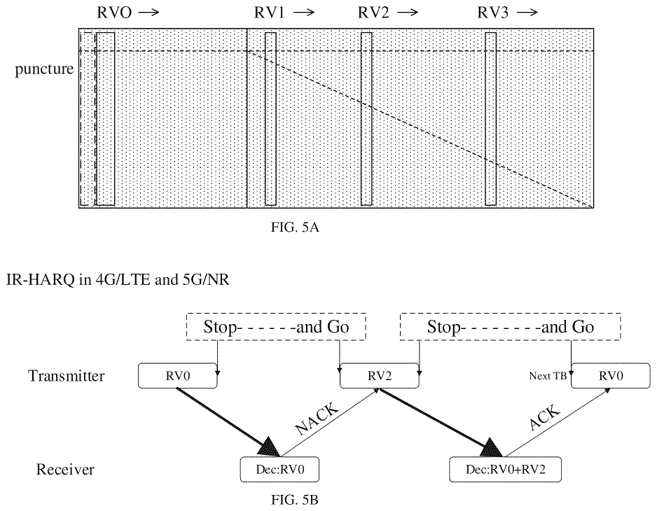

In 4G and 5G, the HARQ mechanism is also called the “stop-and-go” paradigm, where the transmitter will stop transmitting a certain packet at some point, and wait for the acknowledgement (ACK)/NACK feedback. Depending on the feedback, the transmitter may retransmit a part of the current packet, or transmit a new packet. The part of a packet is called a redundancy version (RV). For 5G LDPC, there are all four RVs (i.e., RV0, RV1, RV2, and RV3), defined by their starting positions in the base graph, shown in FIG. 5A.

As shown in FIG. 5B, the transmitter transmits RV0 of a Transport Block (TB), and then stops transmitting and waits for a corresponding feedback (e.g., ACK/NACK). After receiving RV0, the receiver decodes RV0. In a case where RV0 is not decoded successfully, the receiver feeds back a NACK to the transmitter. After receiving the NACK, the transmitter (e.g., the BS) will find a next vacant time-frequency resource block to retransmit a redundancy version (e.g., RV2) corresponding to the initial transmission. After transmitting RV2, the transmitter stops transmitting and waits for a corresponding feedback (e.g., ACK/NACK). After receiving RV2, the receiver (e.g., the UE) will combine the two transmissions and re-decode that packet (e.g., RV0 and RV2), which will typically lead to a greater-than-3 dB gain. In a case where the packet is decoded successfully, the receiver feeds back an ACK to the transmitter. After receiving the ACK, the transmitter stops transmitting the TB, and starts transmitting RV0 of a next TB.

However, the link adaptation and HARQ methods suffers from the following drawbacks: The “stop-and-go” paradigm incurs significant extra delay since the BS needs to wait for an NACK before scheduling a retransmission. The back and forth will incur extra delay.

Disadvantage of the current link adaptation and HARQ is mainly longer latency. In fact, the long latency is incurred mainly from the ACK/NACK reporting and BS scheduling, rather than transmission and decoding.

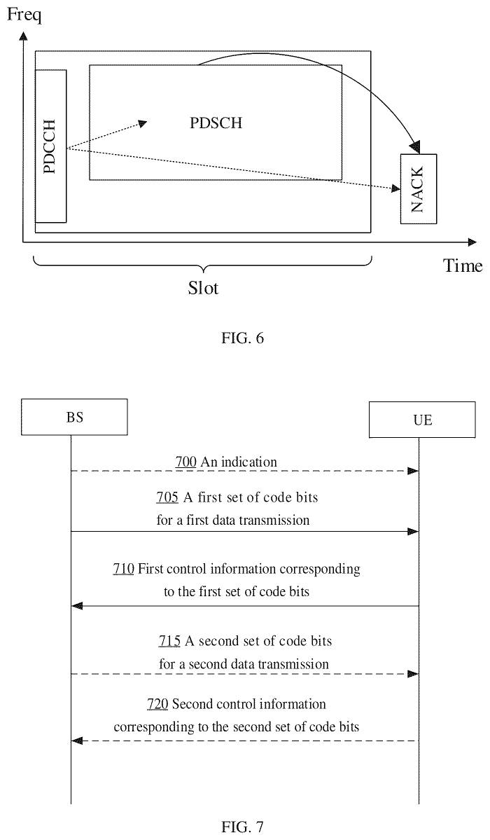

As shown in FIG. 6, in conventional solutions, a NACK (or ACK) associated to a PDSCH transmission cannot be allocated in the same slot, but as early as the nearest subsequent slot. The time gap between the PDSCH packet and NACK is at least T_{proc}, i.e., the processing time.

Problem to be solved is that currently, the timing of ACK/NACK is scheduled by DCI, and it may incur extra delay in reporting ACK/NACK.

To solve the problem described above, the present disclosure provides a method for data transmission, the proposed method is to achieve lower latency UCI report. For example, to support fast decoding and acknowledgements by allowing PDSCH and ACK/NACK in the same slot. Fast decoding and acknowledgements refer to decoding and acknowledgements with low latency.

One possible scenario is fast decoding and acknowledgements where there are multiple decoding attempts and multiple ACK/NACK opportunities during transmission of a codeword or part of a codeword.

Various embodiments of the present disclosure will be described below by way of example. The following embodiments will be illustrated by taking an example where the transmitting apparatus/encoding apparatus is a BS and the receiving apparatus/decoding apparatus is a UE. Reference is now made to FIG. 7, which shows a signaling chart for data transmission according to some embodiments of the present disclosure. The signaling chart involves the BS and the UE.

In step 705, the BS sends a first set of code bits for a first data transmission to a UE over a first set of time domain resources. Accordingly, the UE receives the first set of code bits from the BS.

The first set of code bits may be a codeword or part of a codeword (e.g., an RV). A codeword may be a transport block (TB)/a Code Block Group (CBG)/a Code Block (CB), which is not limited in the present disclosure.

In some embodiments, the first set of code bits may be transmitted over PDSCH. The first set of time domain resources may be a slot, a mini-slot, a TTI, or symbol(s), which is not limited in the present disclosure.

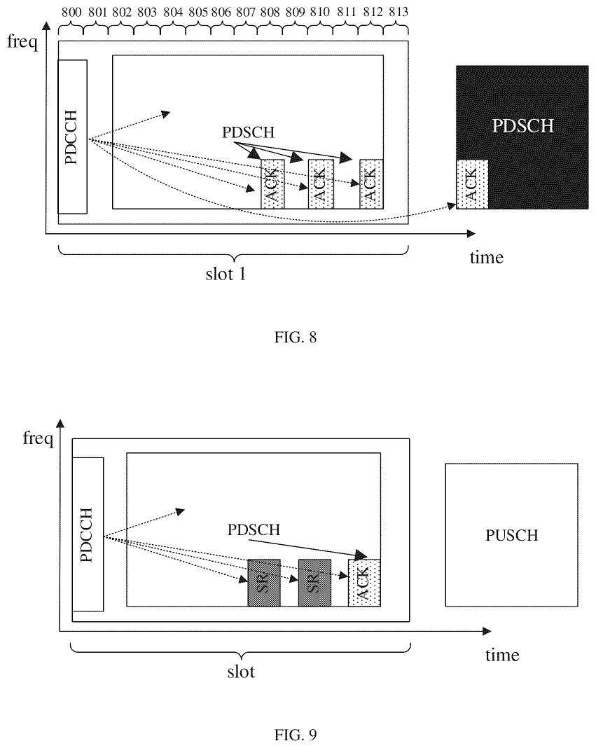

As shown in FIG. 8, PDSCH is transmitted in slot1 which is an example of the first set of time domain resources.

In step 710, the UE sends first control information corresponding to the first set of code bits over a second set of time domain resources. At least some time resources of the first set of time domain resources and the second set of time domain resources are overlapped. Accordingly, the BS receives the first control information corresponding to the first set of code bits over a second set of time domain resources.

In some embodiments, the control information may be uplink control information (UCI).

Optionally, the first control information may indicate decoding result of the first set of code bits. In an example, the first control information may be feedback such as ACK or NACK which indicates whether the first set of code bits is decoded successfully. In another example, the first control information may include decoder state information (DSI) which indicates the decoding confidence about the decoding result.

The following embodiments will be illustrated by taking an example where the first set of time domain resources is a slot.

In a case where the first control information is UCI which includes ACK or NACK, an example of the fast ACK feedback (i.e., ACK feedback with low latency) is illustrated in FIG. 8. As seen, the PDSCH transmission (in slot 1) is associated to four feedback (e.g., ACK) opportunities. Three of the four feedback opportunities are in the same slot (i.e., slot 1), and one of the four feedback opportunities is in a subsequent slot. A feedback opportunity refers to resources for UCI transmission. The resource may be time resources or frequency resources or other type of resources, which is not limited in the present disclosure.

In such case, at least some time resources of the first set of time domain resources and the second set of time domain resources are overlapped. Specifically, part of the time resources for PDSCH transmitted in slot 1 are overlapped with the time resources corresponding to the three feedback opportunities in slot 1.

In conventional solutions, a PDSCH transmission and the control information corresponding to the PDSCH transmission have to be transmitted over different slots. In the present disclosure, since at least some time resources of the first set of time domain resources and the second set of time domain resources are overlapped, a PDSCH transmission and the control information corresponding to the PDSCH transmission may be transmitted in the same slot. In such case, the UE may send the first control information in a timely manner (for example, the UE does not need to wait for a next slot to transmit the UCI), which may reduce the latency for reporting the control information. Accordingly, the BS may receive the first control information while sending the first set of code bits for a first data transmission to the UE. In this way, the BS may obtain the first control information in a timely manner.

As described above, there may be fast ACK/NACK in the same time-freq resource blocks as in PDSCH. In such case, the BS has the freedom choose to allocate associated PDSCH and UCI in the same slot, or consecutive slots, which is backwards compatible and may reduce the feedback latency.

Note that our proposal (i.e. the proposed method) not only supports fast ACK/NACK, but also fast scheduling request (SR) and channel state information (CSI) reports. In such case, SR or CSI may be scheduled in the same slot in which the PDSCH transmission is transmitted. And the benefits are lower-latency scheduled transmissions and timelier (less outdated) CSI measurements, respectively.

An example of the fast SR signaling is illustrated in FIG. 9. As seen, multiple types of UCI (e.g., SR and ACK) can be allocated in the same slot. A feedback opportunity and two SRs are scheduled in the same slot in which the PDSCH transmission is transmitted. The feedback opportunity is for transmission of the feedback corresponding to the PDSCH transmission. In this way, lower-latency scheduled transmissions will be enabled. Alternatively, CSI reports may be scheduled in the same slot in which the PDSCH transmission is transmitted. In this way, timelier CSI measurements will be enabled.

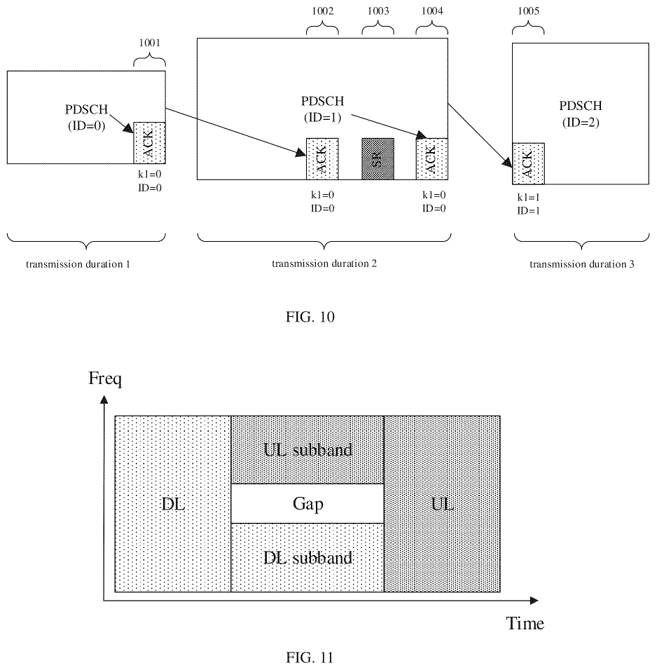

In an implementation, the first control information is identified by an index or ID. The ID may be process ID. Referring to FIG. 10, the ACK with ID=0 corresponds to the PDSCH transmission with ID=0; and the ACK with ID=1 corresponds to the PDSCH transmission with ID=1. HARQ process ID for each ACK/NACK may indicate the ACK/NACK is corresponding to this TB or a previous TB.

In some embodiments, the indication includes one or more timing indicators, and at least one field value of at least one timing indicator maps to k1=0.

Currently, PDSCH-to-HARQ_feedback timing indicator includes 3 bits, and the field value maps to k1={1, 2, 3, 4, 5, 6, 7, 8} slots. In such case, the earliest time for transmitting the feedback is in a slot after the current slot in which the TB is transmitted; that is, k1=1.

In an implementation of the present disclosure, the timing indicator may extend to 4 bits: field value maps to k1={0, 1, 2, 3, 4, 5, 6, 7, 8} slots, where 0 is newly added for SBFD ACK/NACK mode. In such case, the earliest time for transmitting the feedback is in the same slot in which the TB is transmitted; that is, k1=0. The timing indicator may be included in DCI field.

Referring again to FIG. 10, the corresponding timing indicator and HARQ process ID are illustrated. As seen, if k1=0, the corresponding UCI content is associated with PDSCH in the same transmission duration (e.g., a slot).

For PDSCH transmission with ID=0, in a case where k1=0, the corresponding ACK (i.e., ACK with ID=0) is transmitted in the same transmission duration with the PDSCH transmission; in a case where k1=1, the corresponding ACK (i.e., ACK with ID=0) is transmitted in the transmission duration after the current transmission duration in which the PDSCH transmission is transmitted.

Similarly, For PDSCH transmission with ID=1, in a case where k1=0, the corresponding ACK (i.e., ACK with ID=1) is transmitted in the same transmission duration with the PDSCH transmission; in a case where k1=1, the corresponding ACK (i.e., ACK with ID=1) is transmitted in the transmission duration after the current transmission duration in which the PDSCH transmission is transmitted.

Alternatively, the indication may be combined with the RRC configuration, k1={0, 1, 2, 3} slots because shorter time gap is expected.

In some embodiments, the proposed method may be implemented in TDD scenario or sub-band full duplex (SBFD) scenario, which is not limited in the present disclosure.

The time/frequency resource allocation in SBFD is illustrated in FIG. 11. In SBFD scheme, the same BPW is divided into subbands and can be allocated for both UL and DL transmissions. The BS, equipped with advanced interference cancellation techniques, can transmit and receive simultaneously in the same BWP. The UE, without the advanced interference cancellation techniques, cannot transmit and receive at the same time, and has to choose one.

In the currently standardized SBFD specification, only multi-user SBFD is supported. In multi-user SBFD, the gNB schedules DL in one subband/sub-carrier for one UE and UL in another subband/sub-carrier for another UE at the same time.

In some embodiments of the present disclosure, single-user SBFD is introduced, where the gNB schedules DL in one subband/sub-carrier and UL in another subband/sub-carrier for the same UE at the same time.

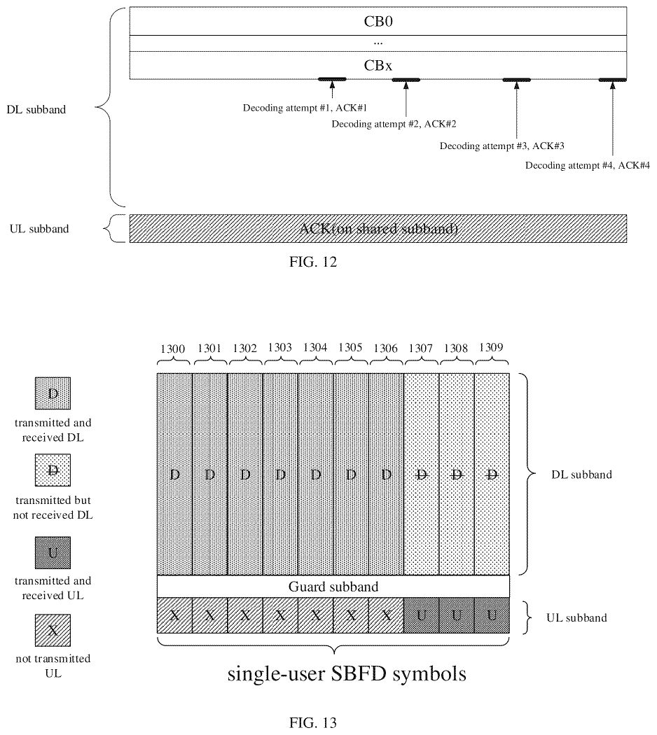

Referring to FIG. 12, CBs (e.g., CB0, CB1, CB2, . . . , CBx) of a TB are transmitted on the DL subband. The UL subband is for the UE to transmit feedback. The UE performs decoding attempts while receiving the CBs of a TB.

In some embodiments, each decoding attempt corresponds to a feedback opportunity, and a codeword can have multiple feedback opportunities. For example, Decoding attempt #1, Decoding attempt #2, Decoding attempt #3, and Decoding attempt #4 correspond to the feedback opportunity “ACK #1,” “ACK #2,” “ACK #3,” and “ACK #4” respectively. In such cases, there are multiple feedback opportunities in the same slot in which the CBs are transmitted.

The UE may perform decoding attempts and transmit feedbacks at any of the multiple feedback opportunities. Once the TB is successfully decoded, the UE may first stop receiving the TB and then transmit an ACK corresponding to the TB within a single frame or slot. This is different from current SBFD where a UE either only receives or only transmits in a frame or slot.

In some embodiments, once the TB is successfully decoded, the UE may transmit an ACK on the UL subband at a corresponding feedback opportunity as early as possible. Alternatively, in a case where the TB is not successfully decoded, the UE may transmit a NACK at a corresponding feedback opportunity. In such case, the UE may report ACK/NACK as early as possible. The feedback time depends on the decoding result of the codeword rather than being fixed, thus providing more flexibility for transmitting the feedbacks. In this way, transmission latency for the control information will be reduced.

In some cases, there are some URLLC transmission requests that require low latency. Thanks to the new scheduling freedom, low-latency feedback and request will be supported.

Referring to FIG. 13 where an example of single-user SBFD is illustrated. The slot is divided into 10 symbols (e.g., symbols 1300, 1301, 1302, 1303, 1304, 1305, 1306, 1307, 1308, and 1309), and the BS schedules a DL transmission up to all 10 symbols. RV(s) of the TB may be carried in these 10 symbols. The UE can perform multiple decoding attempts after each symbol. In this example, after receiving 7 symbols (i.e., symbols 1300, 1301, 1302, 1303, 1304, 1305, 1306), the packet (e.g., the TB) is successfully decoded, thus the UE transmits an ACK in the UL subband (that is, the UE transmits an ACK on subband in symbol 1307) to inform the BS. The BS, although still transmitting, but can hear the ACK in the UL subband thanks to its interference cancellation capability from full-duplex. However, the UE will not receive and decode further symbols (i.e., further symbols 1307, 1308, and 1309 carrying the RV(s) of the TB which is already successfully decoded) after that.

In some embodiments, the UE behavior may include optional UL or DL. For example, the UE can choose to either receive on the DL subband/sub-carrier, or transmit on the UL subband/sub-carrier. In such case, the UE is still in half duplex mode, but the UE has the freedom to choose between UL and DL. For example, if the transmitted TB is not successfully decoded, the UE may receive the RVs of the TB consecutively on the DL subband. If the TB is successfully decoded, the UE may stop receiving RVs of the TB on the DL subband and then transmit an ACK on the UL subband.

If a UE decides to transmit a NACK on UL subband(s), it treats the DL subband(s) in the same symbol as punctured. Referring again to FIG. 13, the UE may transmit NACK(s) on subband in symbols 1301, 1302, 1303, 1304, 1305, or 1306. For example, the TB is not successfully decoded after RV(s) transmitted on DL subband in symbol 1303 is decoded, the UE may then decide to transmit a NACK (not shown) on UL subband in symbol 1304. In a case where the UE is not capable to receive while transmitting, the UE may not be able to receive the RV(s) transmitted on resource DL subband in symbol 1304 while transmitting an NACK on UL subband in symbol 1304. In such case, the UE may treat the DL subband(s) in symbol 1304 as punctured.

If a UE transmits an ACK on UL subband(s) after successful decoding of all CBs, it clears the buffer of the corresponding Log-likelihood ratios (LLRs). For example, as shown in FIG. 13, the TB is successfully decoded after RV(s) transmitted on DL subband in symbol 1306 is decoded, the UE may then decide to transmit an ACK on UL subband in symbol 1307. In addition, the UE may clear the buffer of the corresponding LLRs.

In some embodiments, the UE can transmit ACK(s) on multiple channels, to ensure better reception at BS. Alternatively, the UE may transmit multiple ACKs in the subsequent time resource to ensure the reception at the BS. For example, as shown in FIG. 13, the TB is successfully decoded after RV(s) transmitted on DL subband in symbol 1306 is decoded, the UE may then decide to transmit an ACK repeatedly on UL subband in symbols 1307, 1308, and 1309, thereby ensuring the reception of the ACK at the BS.

In some embodiments, the BS behavior may be always listening on UL. For example, the BS always listens on the UL subband/sub-carrier to monitor whether there is UL transmission based on blind detection or energy detection. In this way, UL transmission will be detected by the BS in real time. In some cases, if UL transmission is detected, the BS assumes the DL transmission on the corresponding symbol is lost/punctured. Because the UE may not be capable of receiving while transmitting.

In some embodiments, if the BS receives an ACK during the transmission of its associated PDSCH, the transmission is stopped. In this way, energy consumption of the BS may be reduced.

In some embodiments, mandatory SBFD awareness may be required for low-latency UCI (including ACK/NACK, SR and CSI). Take fast ACK usage as an example, the UE either receives PDSCH on the DL subband(s), or transmit ACK/NACK on the UL subband(s). Therefore, it is mandatory that UE is SBFD-aware, i.e., knows the frequency locations of both DL and UL subband(s).

The frequency locations of both DL and UL subband(s) may be pre-configured or indicated by an indication.

Optionally, in some embodiments, the proposed method may further include step 700. In step 700, the BS further sends to the UE an indication of the first set of time domain resources and the second set of time domain resources. This step is optional.

Referring again to FIG. 8, time resources for PDSCH and the UCI are both indicated by the indication. The indication may be transmitted on PDCCH. For example, there are 14 symbols in slot 1. The indication indicates that symbols 802, 803, 804, 805, 806, 807, 809, 811 and subband in symbols 808, 810, 812 are for PDSCH; and the UL subband in symbols 808, 810, 812 are for UCI report.

The indication may further indicate the number of the UCI to be transmitted in the first slot. In an example, the indication may indicate that three ACK/NACK feedbacks may be transmitted by specifying their starting symbol position (e.g., offset) and spacing between two feedbacks in terms of symbols.

Alternatively, the indication may indicate the number of resources for the UCI to be transmitted in the first slot. In an example, the indication may indicate three resources for ACK/NACK feedbacks by specifying their starting symbol position (e.g., offset) and spacing between two feedbacks in terms of symbols. In such case, the feedback(s) may be transmitted on at least one of the three resources.

In some embodiments, the indication further indicates relationship between the first set of code bits and the first control information. As shown in FIG. 8, the indication further indicates that UCI to be transmitted on subband in symbols 806, 808, or 810 is feedbacks corresponding to the PDSCH in slot 1.

Alternatively, in another embodiments, the first control information further indicates relationship between the first set of code bits and the first control information. In such case, the first control information further indicates that the first control information corresponds to the first set of code bits. In an implementation, the indication transmitted in step 700 indicates that there are some symbols for UCI report corresponding to the TB, but does not indicate which specific symbol is for UCI report corresponding to the TB. Rather, the UCI itself indicates which TB it corresponds to.

Referring again to FIG. 10, for example, the indication indicates that UL subband in symbols 1001, 1002, 1003, 1004, and 1005 are for UCI report, but it does not indicate that the UCI report corresponding to which specific PDSCH. In such case, the UCI itself indicates which PUSCH it corresponds to. For example, an ACK transmitted on subband 1001 in transmission duration 1 or on subband 1002 in transmission duration 2 indicates that it corresponds to the PDSCH transmitted in transmission duration 1; an ACK transmitted on subband 1004 in transmission duration 2 or on subband 1005 in transmission duration 3 indicates that it corresponds to the PDSCH transmitted in transmission duration 2. As such, once the BS receives an ACK, it will know which PDSCH the ACK corresponds to.

In some embodiments, the indication further indicates whether NACK is to be transmitted in a case where the first set of code bits is not successfully decoded.

In some cases, because UE may be half duplex, if a UE transmits NACK on UL subband(s), then it cannot receive PDSCH symbols at the same time. For example, the UE may transmit a NACK if a PDSCH is not decoded successfully. In such case, the BS may still transmit PDSCH symbols to the UE at the same time when the UE is transmitting a NACK. However, the UE may not be able to receive the PDSCH symbols while it is transmitting the NACK. Therefore, transmitting the NACK may affect the receiving and decoding of the PDSCH. In some cases, NACK does not need to be transmitted. As such, the receiving and decoding of the PDSCH may not be affected or interrupted, and the UE may decode the PDSCH at an earlier time.

In some embodiments, the indication further indicates the interval for resources for transmission of the NACK.

Since it may not be necessary to receive NACKs frequently, the interval for resources for transmission of the NACK may be set. In such case, NACK is transmitted sparsely on the UL subband(s) and symbols. For example, NACK is only once on every X symbols, where X can be 2, 3, 4, 5, 6, 7, which is not limited in the present disclosure. In this way, resources for transmission of the NACK are relatively spares, and impact on the receiving and decoding of the PDSCH transmission will be reduced.

In some embodiments, the first set of time domain resources includes one or more non-SBFD symbols and one or more SBFD symbols.

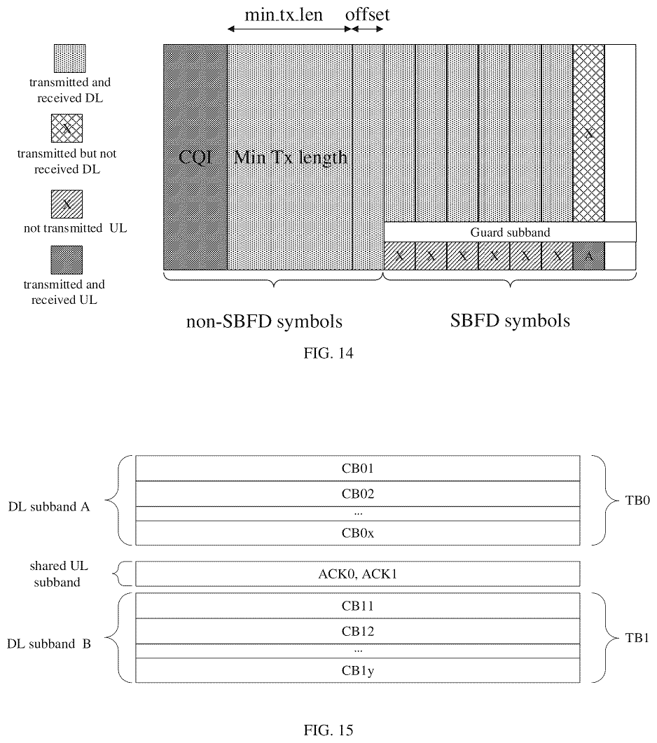

The hybrid SBFD and non-SBFD frame structure is illustrated in FIG. 14. There are non-SBFD symbols and SBFD symbols in a slot. For example, the UE may not be able to decode the TB successfully by decoding the RV(s) within the minimum transmission length. The UE may at least receive RV(s) with the minimum transmission length before performing the first decoding attempt. In such case, the symbols within the minimum transmission length can take the non-SBFD way because no ACK will be transmitted during this period. Beyond this length (i.e., the minimum transmission length), decoding and feedback can be performed, and the UL subband should be allocated to UE for ACK signal transmission.

In some embodiments, the one or more SBFD symbols are consecutive in the first set of time domain resources, or the one or more non-SBFD symbols are consecutive in the first set of time domain resources, or both the one or more SBFD symbols are consecutive in the first set of time domain resources and the one or more non-SBFD symbols are consecutive in the first set of time domain resources.

As shown in FIG. 14, the SBFD symbols are consecutive, and the UE may feedback an ACK on the UL subband once the TB is successfully decoded. Since frequent switching between SBFD and non-SBFD is hardware-unfriendly, but frequent ACK/NACK opportunities are needed for low latency, the SBFD symbols with reserved UCI subband(s) are consecutive. As such, frequent switching between SBFD and non-SBFD will be avoided, and the feedback can be transmitted in a timely manner.

In addition, the non-SBFD symbols may be consecutive. For example, as shown in FIG. 14, the UL CQI and RV(s) of the minimum transmission length are transmitted on consecutive non-SBFD symbols, since there may be no need for the UE to transmit feedback at the same time.

In some embodiments, the non-SBFD symbols are transmitted earlier than the one or more SBFD symbols. For example, the non-SBFD symbols are the first few symbols in the slot, and the SBFD symbols are the last a few symbols in the slot, because there may be no need for the UE to transmit feedback at the beginning of a slot.

In some embodiments, the starting position of the one or more SBFD symbols is based on a time for transmitting the first set of code bits of the minimum transmission length and a processing time at a receiving device to process and decode the first set of code bits.

For example, the SBFD symbols start after a certain point, calculated by min_tx_len+Tproc, where min_tx_len corresponds to the minimum code length that a CB is decodable, and offset is related to the decoding time T_{proc}. As shown in FIG. 14, the starting position of the one or more SBFD symbols is at min_tx_len+Tproc, where min_tx_len is time of transmitting the first set of code bits of the minimum transmission length, and Tproc is processing time at a receiving device to process and decoded the first set of code bits. As such, the starting position of the one or more SBFD symbols is determined in a flexible way, and the utilization of the first set of time domain resources may be improved.

In some embodiments, the UE further transmits a SR or a CSI over the second set of time domain resources. The first control information is transmitted earlier than the SR or a CSI. Accordingly, the BS receives the SR or the CSI.

In some cases, the first control information is required to be transmitted timelier than the SR or CSI. The first control information is transmitted earlier than the SR or a CSI. In an example, there are rules for SBFD resource allocation for SR and CSI: because very frequent SR and CSI are unnecessary, and frequent switching between SBFD and non-SBFD is hardware-unfriendly, one or two symbols per slot may be reserved for SR and CSI. The specific location for SR and CSI can be at the end of a slot, to reduce switching.

In an example, there are rules for SBFD resource allocation for mixed ACK/NACK, and SR and CSI: consecutive SBFD symbols can be adopted, where one or two symbols are reserved for SR and CSI (e.g., the last symbols in a slot), and all other symbols are reserved for ACK/NACK.

In some embodiments, the BS further sends a third set of code bits over a third set of time domain resources. The third set of code bits is a redundancy version of the first set of code bits, and a minimum transmission length corresponding to the third set of code bits is shorter than a minimum transmission length corresponding to the first set of code bits.

As described above, the UE may start decoding after receiving the RV(s) of minimum transmission length. However, if the PDSCH redundancy version (RV) corresponds to a retransmission (e.g., new data indicator not toggled), then min_tx_len=1. In other words, if an RV corresponding to the retransmission of previous TB, the UE may start decoding the RV once the first symbol of the RV is received (i.e., the minimum transmission length is 1 symbol). As such, the UE may decode the RV together with previous RV(s) successfully at an early time.

In some embodiments, the indication is determined based on configuration, and the indication may be preconfigured or carried in RRC signaling or DCI.

In an example, for RRC, the pre-configuration is sent beforehand and is not a one-time indication. For DCI, it may be an indication field to allocate the feedback resources in real time.

In another example, the configuration is a static configuration according to standard specifications. The configuration can be based on other parameters such as the resource position allocated for the data transmission. This requires no dedicated indication.

In some embodiments, two types of UEs are allowed in the network, those support SBFD and those do not support SBFD (old devices). Whether the UE supports SBFD may be reported as a part of UE capability during the initial access procedures.

In some embodiments, the indication may indicate or configure whether to activate SBFD/FD mode for UCI (ACK/NACK, SR). Because UE needs to know which mode to adopt. The indication may be carried in RRC.

In some embodiments, indication further indicates a first set of frequency resources for sending the first set of code bits, or a second set of frequency resources for receiving the first control information, or both the first set of frequency resources for sending the first set of code bits and the second set of frequency resources for receiving the first control information.

The indication may indicate time-freq resource (including symbol locations and subband locations) reserved for reporting ACK/NACK and/or SR.

Detailed resource allocation rules can be specified. For example, the SBFD subband(s) to PDSCH/UCI mapping may be designed as:

The DL subband(s) correspond to higher frequency, and is used for PDSCH.

The UL subband(s) corresponds to lower frequency, and is used for PUCCH/UCI (e.g., ACK/NACK, SR).

In an implementation, the DL subband(s) is wider than the UL subband(s). Because compared to UCI (e.g., 1-bit ACK), PDSCH transmission may need more transmission resources.

In some embodiments, the second set of time domain resources are indicated by a first starting position and a first offset, the first starting position indicates a time resource for sending an initial bit of the first set of code bits, and the first offset is a time interval between two contiguous time resources for sending the first set of code bits.

In some embodiments, the second set of frequency resources are indicated by a second starting position and a second offset; the second starting position indicates a frequency resource for sending an initial bit of the first set of code bits; and the second offset is a frequency interval between two contiguous frequency resources for sending the first set of code bits.

Since it may be inefficient to specify each time-frequency resource to be scheduled for DL and UL transmission one by one (e.g., (t1, f1), (t2, f2), . . . (tn, fn)), one resource and the relative offset with respect to the resource may be specified.

For example, there are n resources to be allocated for DL and UL transmission. Resource (t1, f1) is specified. In addition, offsets Δt and Δf are defined. In such case, the remaining n−1 resources will be derived as (t1+Δt, f1+Δf), (t1+2Δt, f1+2Δf), . . . , (t1+(n−1)Δt, f1+(n−1)Δf). In this way, a large number of resources will be allocated efficiently without incurring much overhead.

Some embodiments of the present disclosure provide a method for transmission block size (TBS) calculation.

TBS calculation may be based on a minimum transmission length for the first set of code bits.

TBS calculation is based on total number of allocated resource elements (REs) for the UE, code rate, modulation order, and number of MIMO layers. The TBS calculation also needs to be modified because the number of code bits (channel resource) actually used for successful decoding is no longer a constant, but depending on the decoding results of multiple decoding attempts. This is different from 5G where there is only 1 decoding opportunity and thus the code bits for decoding is fixed.

Specifically, the number of resource elements (#RE) is calculated differently from 5G. There are two alternatives:

Alternative 1: only count #REs within the minimum transmission length (min_tx_len). At the same time, use an aggressive (higher than default) MCS index selection to improve spectrum efficiency.

Alternative 2: count all symbols (i.e. REs), but exclude the REs in UL subband(s) and guard subband(s).

In Alternative 1, more aggressive MCS and higher effective code rate are allowed, leading to higher spectrum efficiency. In Alt 2, more conservative MCS is allowed and lower error probability will be achieved.

In some embodiments, in step 715, the BS further sends a second set of code bits for a second data transmission over the first set of time domain resources. This step is optional.

In step 720, the UE sends second control information corresponding to the second set of code bits over the second set of time domain resources. Accordingly, the BS receives the second control information corresponding to the second set of code bits over the second set of time domain resources. At least some time resources of the first set of time domain resources and the second set of time domain resources are overlapped, and the second control information further indicates the relationship between the second set of code bits and the second control information. This step is optional.

Referring to FIG. 15, TB0 includes CB01, CB02, . . . , and CB0x, and TB0 is transmitted on DL subband A. TB1 includes CB11, CB12, . . . , and CB1y, and TB1 is transmitted on DL subband B. The feedbacks corresponding to TB0 (e. g., ACK0) and feedback corresponding to TB1 (e.g., ACK1) are transmitted on the shared UL subband respectively. Once TB0 is successfully decoded, the UE may feedback an ACK (i.e., ACK0). Similarly, once TB1 is successfully decoded, the UE may feedback an ACK (i.e., ACK1). Since each ACK is identified by an index, the BS will know which TB the ACK is corresponding to. Moreover, as the feedbacks corresponding to different TBs are transmitted on the shared UL subband, the frequency resources will be utilized in a more efficient way.

It will be appreciated that the first set of code bits and the second set of code bits may be transmitted to the same UE or different UEs.

Also, it is expected that pure full-duplex (FD) transmissions will be adopted in future wireless systems. So the methods described in this proposal also applies to pure FD. The existing subband full-duplex (SBFD) or future pure full-duplex (FD) may be used to support low-latency ACK. In the future, new UCI content should also be supported in the low-latency UCI framework using SBFD.

The distinguishing features of the idea are:
Low-latency UCI (including ACK/NACK, SR and CSI) using SBFD;
Single-user SBFD instead of multi-user SBFD;
RRC/DCI signaling to indicate low-latency UCI using SBFD, and resource allocation;
SBFD resource allocation depending of UCI content; and
Feedback rules for low-latency UCI.

Compared to legacy HARQ with non-SBFD, the advantageous effects are: higher throughput, lower latency, saving power, reducing interference, and less sensitive to imperfect channel estimation.

In the present disclosure, existing subband full-duplex (SBFD) or future pure full-duplex (FD) may be used, enabling lower-latency UCI (including ACK/NACK). The BS always listens on UL subband/sub-carrier to monitor whether there is UL transmission, allowing early stop of transmission at BS, which saves transmitting energy. There is signaling to activate SBFD/FD mode, and PDSCH-to-ACK timing/resource indicator, leading to flexibility and backward compatibility. New TBS calculation to consider actually transmitted length is proposed, allowing more aggressive MCS and higher effective code rate, and as a results higher spectrum efficiency. Rules for SBFD resource allocation for ACK/SR/CSI are proposed, enabling higher channel resource utilization. Several detailed protocol design rules and behaviors are proposed to support a complete end-to-end design. Moreover, design of SBFD resource allocation is proposed to improve the spectrum efficiency.

Some embodiments of the present disclosure provide a computer-readable storage medium (e.g., a non-transitory computer-readable storage medium). The computer-readable storage medium has stored thereon program instructions that, when run on a network device/terminal device, cause the network device/terminal device to execute one or more steps of the method for beam management as described in any one of the above embodiments.

For example, the computer-readable storage medium includes, but is not limited to, a magnetic storage device (e.g., a hard disk, a floppy disk or a magnetic tape), an optical disk (e.g., a compact disk (CD), or a DVD), a smart card, and a flash memory device (e.g., an erasable programmable read-only memory (EPROM), a card, a stick or a key driver). Various computer-readable storage media described in the embodiments of the present disclosure may represent one or more devices and/or other machine-readable storage media, which are used for storing information. The term “computer-readable storage medium” may include, but is not limited to, wireless channels and various other media capable of storing, containing and/or carrying instructions and/or data.

Some embodiments of the present disclosure further provide a computer program product. The computer program product includes program instructions carried on a non-transitory computer-readable storage medium. When executed on a network device/terminal device, the computer program instructions cause the network device/terminal device to perform one or more steps of the method for data transmission as described in the above embodiments.

Beneficial effects of the computer-readable storage medium and the computer program product are the same as the beneficial effects of the method for data transmission as described in some of the above embodiments, and details will not be repeated here.

The foregoing descriptions are merely specific implementations of the present disclosure, but the protection scope of the present disclosure is not limited thereto. Any changes or replacements within the technical scope of the present disclosure shall be included in the protection scope of the present disclosure. Therefore, the protection scope of the present disclosure shall be subject to the protection scope of the claims.

In some aspects of the present disclosure, there is provided a computer program comprising instructions. The instructions, when executed by a processor, may cause the processor to implement a method of the present disclosure.

In some aspects of the present disclosure, there is provided an integrated circuit. The integrated circuit includes one or more logic circuits for executing the steps of the method for data transmission of the present disclosure.

In some aspects of the present disclosure, there is provided an apparatus comprising means (e.g., at least one processor) to implement a method of the present disclosure. The apparatus may be device (that is, a terminal device or a network device) or a module or component in the device. The at least one processor may execute instructions stored in a computer-readable medium to implement the method.

The apparatus may be a communication device or an apparatus implemented in a communication device. For example, the apparatus implemented in a communication device may be an integrated circuit, which in some contexts may be known by other colloquial names, such as chip, modem, modem chip, baseband chip, or baseband processor. In some implementations, one or more integrated circuits can be packaged into a system-on-chip, a system-in-package, or a multi-chip module. The apparatus may comprise one or more integrated circuits or comprise one or more integrated circuits and other discrete components.

The solutions described in the disclosure is applicable to a next generation (e.g. sixth generation (6G) or later) network, or a legacy (e.g. 5G, 4G, 3G or 2G) network. The proposed method applies to a wide range of communication networks, such as 5G+, 6G, WiFi, NTN and distributed or self-organized networks.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

The terms “apparatus” and “device” are used exchangeable.

In the disclosure, the word “a” or “an” when used in conjunction with the term “comprising” or “including” in the claims and/or the specification may mean “one,” but it is also consistent with the meaning of “one or more,” “at least one,” and “one or more than one” unless the content clearly dictates otherwise. Similarly, the word “another” may mean at least a second or more unless the content clearly dictates otherwise.

In the disclosure, the words “first,” “second,” etc., when used before a same term (e.g., UE, or an operating step) does not mean an order or a sequence of the term. For example, the “first UE” and the “second UE,” means two different UEs without specially indicated, and similarly, the “first step” and the “second step” means two different operating steps without specially indicated, but does not mean the first step have to happen before the second step. The real order depends on the logic of the two steps.

The terms “coupled,” “coupling,” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B,” as used herein, is interchangeable with the expression “A and/or B.” It refers to a list in which you may select A or B or both A and B. Similarly, “at least one of A, B, or C,” as used herein, is interchangeable with “A and/or B and/or C” or “A, B, and/or C.” It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The terms “receive,” “detect,” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive,” “detect,” and “decode” may indicate different procedure at receiving side to obtain the information. Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

The following acronyms and abbreviations may be used in the present disclosure:

| | Acronym/Abbreviation/ |
|---|---|
| Full Name | Initialism |
| Long Term Evolution | LTE |
| New Radio | NR |
| Forward error correction | FEC |
| Multiple Access | MA |
| Quality of Service | QoS |
| low-density parity check codes | LDPC |
| cyclic redundancy check | CRC |
| ultra-reliable low latency communications | uRLLC |
| Enhanced mobile broadband | eMBB |
| massive Machine Type Communications | mMTC |
| non-terrestrial networks | NTN |
| Internet of Things | IoT |
| Bit Error Rate | BER |
| Block Error Rate | BLER |
| Packet Error Rate | PER |
| Spectral Efficiency | SE |
| Hybrid automatic repeat request | HARQ |
| Channel Quality Indicator | CQI |
| Modulation Coding Scheme | MCS |
| gNodeB or 5G base station | gNB |
| user equipment | UE |
| Radio Resource Control | RRC |
| Radio Network Temporary Identifier | RNTI |
| Uplink Control Information | UCI |
| Downlink Control Information | DCI |
| Physical Broadcast Channel | PBCH |
| Half-radio frame bit | HRF |
| Synchronization Signal Block | SSB |
| unequal error protection | UEP |
| variable node | VN |
| check node | CN |
| Log-likelihood ratio | LLR |
| Successive cancellation | SC |
| Successive cancellation list | SCL |
| Belief propagation | BP |

1. A method for data transmission, comprising:
sending a first set of code bits for a first data transmission over a first set of time domain resources and a first set of frequency domain resources; and
receiving first control information corresponding to the first set of code bits over a second set of time domain resources and a second set of frequency domain resources,
wherein at least some time resources of the first set of time domain resources and the second set of time domain resources overlap, and at least some frequency resources of the first set of frequency domain resources and the second set of frequency domain resources overlap.

2. The method of claim 1, further comprising:
sending an indication of the first set of time domain resources and the second set of time domain resources.

3. The method of claim 2, wherein the indication further indicates one or more time domain resources for receiving the first control information corresponding to the first set of code bits, and the one or more time domain resources belong to the second set of time domain resources.

4. The method of claim 1, wherein the first control information further indicates that the first control information corresponds to the first set of code bits.

5. The method of claim 1, further comprising:
sending a second set of code bits for a second data transmission over the first set of time domain resources; and
receiving second control information corresponding to the second set of code bits over the second set of time domain resources,
wherein the second control information further indicates that the second control information corresponds to the second set of code bits.

6. A method for data transmission, comprising:
receiving a first set of code bits for a first data transmission over a first set of time domain resources and a first set of frequency domain resources; and
sending first control information corresponding to the first set of code bits over a second set of time domain resources and a second set of frequency domain resources,
wherein at least some time resources of the first set of time domain resources and the second set of time domain resources overlap, and at least some frequency resources of the first set of frequency domain resources and the second set of frequency domain resources overlap.

7. The method of claim 6, further comprising:
receiving an indication of the first set of time domain resources and the second set of time domain resources.

8. The method of claim 7, wherein the indication further indicates one or more time domain resources for receiving the first control information corresponding to the first set of code bits, and the one or more time domain resources belong to the second set of time domain resources.

9. The method of claim 6, wherein the first control information further indicates that the first control information corresponds to the first set of code bits.

10. The method of claim 6, further comprising:
receiving a second set of code bits for a second data transmission over the first set of time domain resources; and
sending second control information corresponding to the second set of code bits over the second set of time domain resources,
wherein the second control information further indicates that the second control information corresponds to the second set of code bits.

11. An apparatus for data transmission, comprising:
at least one processor; and
at least one memory coupled to the at least one processor, the at least one memory storing at least part of instructions that, when executed by the at least one processor, causes the apparatus to perform:
sending a first set of code bits for a first data transmission over a first set of time domain resources and a first set of frequency domain resources; and
receiving first control information corresponding to the first set of code bits over a second set of time domain resources and a second set of frequency domain resources,
wherein at least some time resources of the first set of time domain resources and the second set of time domain resources overlap, and at least some frequency resources of the first set of frequency domain resources and the second set of frequency domain resources overlap.

12. The apparatus of claim 11, wherein the at least part of the instructions further causes the apparatus to perform:
sending an indication of the first set of time domain resources and the second set of time domain resources.

13. The apparatus of claim 12, wherein the indication further indicates one or more time domain resources for receiving the first control information corresponding to the first set of code bits, and the one or more time domain resources belong to the second set of time domain resources.

14. The apparatus of claim 11, wherein the first control information further indicates that the first control information corresponds to the first set of code bits.

15. The apparatus of claim 11, wherein the at least part of the instructions further causes the apparatus to perform:
sending a second set of code bits for a second data transmission over the first set of time domain resources; and
receiving second control information corresponding to the second set of code bits over the second set of time domain resources,
wherein the second control information further indicates that the second control information corresponds to the second set of code bits.

16. An apparatus for data transmission, comprising:
at least one processor; and
at least one memory coupled to the at least one processor, the at least one memory storing at least part of instructions that, when executed by the at least one processor, causes the apparatus to perform:
receiving a first set of code bits for a first data transmission over a first set of time domain resources and a first set of frequency domain resources; and
sending first control information corresponding to the first set of code bits over a second set of time domain resources and a second set of frequency domain resources,
wherein at least some time resources of the first set of time domain resources and the second set of time domain resources overlap, and at least some frequency resources of the first set of frequency domain resources and the second set of frequency domain resources overlap.

17. The apparatus of claim 16, wherein the at least part of the instructions further causes the apparatus to perform:
receiving an indication of the first set of time domain resources and the second set of time domain resources.

18. The apparatus of claim 17, wherein the indication further indicates one or more time domain resources for receiving the first control information corresponding to the first set of code bits, and the one or more time domain resources belong to the second set of time domain resources.

19. The apparatus of claim 16, wherein the first control information further indicates that the first control information corresponds to the first set of code bits.

20. The apparatus of claim 16, wherein the at least part of the instructions further causes the apparatus to perform:
receiving a second set of code bits for a second data transmission over the first set of time domain resources; and
sending second control information corresponding to the second set of code bits over the second set of time domain resources,
wherein the second control information further indicates that the second control information corresponds to the second set of code bits.
